(19) United States
(12) Patent Application Publication
(10) Pub. No.: US 2021/0117304 A1
(43) Pub. Date: Apr. 22, 2021

(54) BREAKPOINT GENERATION FROM STATIC ANALYSIS

(71) Applicant: International Business Machines Corporation, Armonk, NY (US)

(72) Inventors: Nicholas Marion, Poughkeepsie, NY (US); Deborah A. Furman, Staatsburg, NY (US); Michael E. Gildein, Wappingers Falls, NY (US); Anthony Thomas Sofia, Hopewell-Junction, NY (US)

(21) Appl. No.: 16/658,187

(22) Filed: Oct. 21, 2019

(51) Int. Cl. G06F 11/36; G06F 8/41

(52) U.S. Cl. CPC G06F 11/3604; G06F 8/41; G06F 11/3664

(57) ABSTRACT

Aspects of the invention include receiving, by a processor, source code for a software program. A static analysis of the source code is performed by the processor based at least in part on one or more breakpoint generation rules. Breakpoints are inserted, by the processor, into the source code based at least in part on the static analysis and the one or more breakpoint generation rules. The source code with the inserted breakpoints is compiled, by the processor, into object code for the software program.

### BACKGROUND

The present invention generally relates to testing computer software, and more specifically, to breakpoint generation from static analysis of source code.

In order to test software code, breakpoints can be placed in the code such that a tester can use the breakpoints programmatically to inject errors, create timing windows, validate storage, pause execution for manual intervention, and perform other actions to test the software code.

Today, breakpoints are generally manually added by a software developer after collaborating with a tester and usually after a code review. Testers then have to manually determine the tests to execute against the breakpoints. This can include figuring out how to drive the breakpoints, what action to take when each breakpoint is hit, and how to validate the results of the actions.

### SUMMARY

Embodiments of the present invention are directed to breakpoint generation from static analysis. A non-limiting example computer-implemented method includes receiving, by a processor, source code for a software program. A static analysis of the source code is performed by the processor based at least in part on one or more breakpoint generation rules. Breakpoints are inserted, by the processor, into the source code based at least in part on the static analysis and the one or more breakpoint generation rules. The source code with the inserted breakpoints is compiled, by the processor, into object code for the software program.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a system for breakpoint generation from static analysis according to one or more embodiments of the present invention;

FIG. 2 depicts a process flow diagram of breakpoint generation from static analysis according to one or more embodiments of the present invention;

FIG. 3 depicts a process flow diagram of executing object code that includes breakpoints generated from static analysis according to one or more embodiments of the present invention;

FIG. 4 depicts a cloud computing environment according to one or more embodiments of the present invention;

FIG. 5 depicts abstraction model layers according to one or more embodiments of the present invention; and

FIG. 6 illustrates a system for breakpoint generation from static analysis according to one or more embodiments of the present invention.

The diagrams depicted herein are illustrative. There can be many variations to the diagrams, or the operations described therein without departing from the spirit of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

### DETAILED DESCRIPTION

One or more embodiments of the present invention provide a static analysis tool to run against source code to identify locations for breakpoints in the source code based on pre-defined rules or rules generated using execution result analysis. The static analysis tool, or external tool at a subsequent state in a pipeline, dynamically inserts the breakpoints into the source code at the identified locations and generates a breakpoint library that contains an entry for each of the breakpoints. Each entry can include a unique breakpoint name or identifier for its corresponding breakpoint as well as a severity level indicator. The severity level can be used to determine an action to take when the breakpoint is executed. A tester can use all of the breakpoints in the breakpoint library in their test cases, basing their actions on the breakpoint identifier and/or category such as a severity level.

In accordance with one or more embodiments of the present invention there are different levels of severity, such as, but not limited to, high severity and low severity, which each correspond to different actions. For example, the action performed when a low severity breakpoint is executed may include logging the error and storing the log data, and the action performed when a high severity breakpoint is executed may include logging the error and dumping or taking a snapshot of the storage while outputting an exception message. The severity levels of particular breakpoints can be adjusted based on performing analytics on the results of the actions. The action can also include logging an identifier of the breakpoint and a timestamp of the current time.

As used herein, the term “static analysis” refers to analyzing source code and determining locations for breakpoints based on the analysis. The input to the static analysis is the input source code that is being analyzed and predefined rules, and the output from the static analysis is the input source code with breakpoints added based on the analyzing.

In accordance with one or more embodiments of the present invention, static analysis is used prior to compiling the software code to identify areas of the software code to set breakpoints. The identifying can be based on pre-defined rules that describe various criterion or models such as, but not limited to, an area of code with high complexity (e.g., nested if statements, multiple loops). One or more embodiments of the present invention dynamically generate a breakpoint in the source code at a point near, in, before, and/or after the code that matches the rule criteria. A mechanism for categorizing each breakpoint can include using a naming convention for the breakpoints or tagging the breakpoints to allow sets or libraries of breakpoints to dynamically be turned on and off during or before real time execution.

For example, a set of breakpoints that match certain criterion can be tagged as being high severity and/or with a recovery indicator allowing these breakpoints to be enabled or disabled dynamically during execution of the software code. Recovery is another example of a category that a breakpoint can be tagged with. The recovery indicator may indicate that the code and/or test are on a code path related to recovery functions for the application or the system under test. In accordance with one or more embodiments of the present invention, a breakpoint handler captures certain log data to verify results of the test that occurred when the breakpoint was hit, and the associated action was executed.

In another example, one or more breakpoints are set in each code segment path flow that differs substantially based on lines of code established from a control flow graph produced by static code analysis. Control flow graphs graphically represent potential control flow of execution. By looking at both the flow and the size of the segments in the control flow graph, breakpoints can be set to at minimum ensure execution coverage during testing. Static analysis can be used to determine different code path flows and place breakpoints to ensure that when either code path is driven, a breakpoint will be hit. This ability to categorize and group breakpoints enables reduced overhead and increased performance of software code that more closely mimics a real-world execution of the software code or system under test.

One or more embodiments of the present invention provide technological improvements over current manual methods of inserting breakpoints. A disadvantage of contemporary approaches is that it is a manual process that requires a programmer and/or tester to analyze code to determine where to insert breakpoints and to determine what action to take when a breakpoint is hit or executed. In addition, the programmer and/or tester manually inserts the breakpoints and corresponding actions. Contemporary approaches can be expensive in terms labor cost as well as error prone due for example, to human errors in selecting where to insert the breakpoints and/or in specifying the corresponding actions. One or more embodiments of the present invention provide technical solutions to one or more of these disadvantages by automating the determination of where to insert the breakpoints by performing static analysis on source code using predefined rules. In this manner, less time is required of the programmers and/or testers. In addition, fewer errors may be encountered so that tests are less likely to have to be repeated because they did not collect all of the data due to incorrect placement of breakpoints.

Another disadvantage of contemporary approaches is that programmers and/or testers may insert more breakpoints than required in order to be sure that no data is missed. Because breakpoints cause an action, or additional instructions, to be performed, they can have an impact on the performance and/or timing of the software program being tested. Inserting a large number of breakpoints, such as between every line or at every entry point within a code segment may introduce significant performance penalties and overhead therefore potentially changing the software program being tested. This may result in inaccurate test results. One or more embodiments of the present invention provide technical solutions to one or more of these disadvantages by allowing sets of breakpoints to dynamically be turned on or off during real time execution of the software program. In this manner, breakpoints can be targeted for specific tests which can result in reduced overhead and increased performance of the software program being tested. In addition, by executing fewer breakpoints, the test can more closely mimic a real-world execution of the software or system under test.

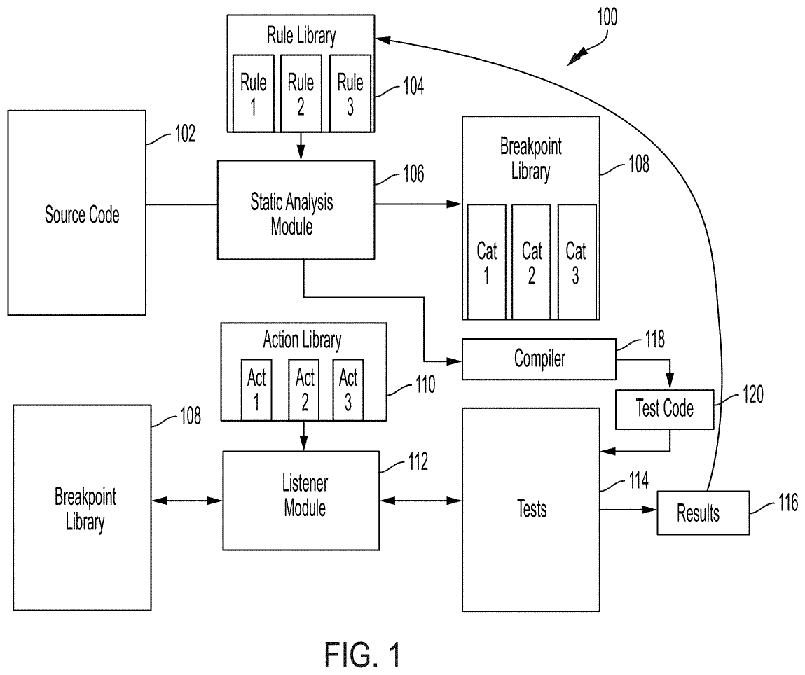

Turning now to FIG. 1, a block diagram of a system 100 for breakpoint generation from static analysis is generally shown in accordance with one or more embodiments of the present invention. In accordance with one or more embodiments of the present invention all of the components in the system 100 are located on one or more processors in the same data center. In accordance with one or more other embodiments of the present invention, all or a portion of the components of the system 100 are located on different processors in different data centers and/or in a cloud computing environment.

The components of the system 100 shown in FIG. 1 include source code 102, a rule library 104, a static analysis module 106, a breakpoint library 108, an action library 110, a listener module 112, tests module 114, results 116, compiler 118, and test code 120. The source code 102, rule library 104, breakpoint library 108, action library 110, test code 120, and results 116 can be stored in any configuration and in any type of storage and/or memory. The static analysis module 106 can include static analysis tools to perform the functions described herein. The static analysis module 106 analyzes the source code 102 based on one or more rules in the rule library 104 to determine locations for inserting breakpoints in the source code 102. The rules in the rule library 104 can include rules such as, but not limited to: a rule about inserting a breakpoint if more than a specified number of nested IF statements are located in the source code; a rule about inserting a breakpoint if a particular function call is located in the source code; a rule about inserting a breakpoint if an instruction to write or read from storage is located in the source code; and/or a rule about inserting a breakpoint if more than a specified number of nested loops are located in the source code.

The rule library 104 can be created by a developer, tester and/or organization, and all or a subset of the rules can be applied to source code being tested. By providing the user with the ability to turn selected rules on or off, the inserting of breakpoints can be tailored to particular tests. In addition, or alternatively, the rule library 104 can be populated with common coding errors or based on coding standards (e.g., best practices or guidelines) for a given language.

An example of a rule is that a best practice may include that every switch statement should have a default statement (otherwise there is potential for a code defect during execution). This may be expressed as:

switch(foo) {
case bar:
print(‘bar’);
break;
default:
print(‘foobar’);
}

Another example of a best practice rule is not instantiating variables before using them so they may be null causing a null pointer error. This may be expressed as:

int foo:
foo=foobar; //omitting this line may cause a defect
print(foo+10);

The static analysis module 106 inserts breakpoints into the source code and stores unique identifiers of each of the breakpoints in the breakpoint library 108. The breakpoint library 108 shown in FIG. 1 includes categories for the breakpoints. The categories can include, but are not limited to: function calls, storage accesses, and nested looping. Breakpoints within a particular category can be enabled or disabled by a tester as a group depending, for example, on the focus of the particular test. In addition, or alternatively, individual breakpoints can be enabled or disabled individually. In accordance with one or more embodiments of the present invention, the breakpoint library also stores a severity level of each of the breakpoints which can be used to determine what action to take when the breakpoint is executed.

The static analysis module 106 sends the source code with the breakpoints inserted to the compiler 118 (or interpreter) to generate object code which is stored for execution as the test code 120. The test code 120 is executed by the tests module 114. In accordance with one or more embodiments of the present invention, when an instruction in the test code 120 that specifies a breakpoint is executed, the listener module 112 (also referred to herein as a “breakpoint handler”) is invoked (or called by the test code) and the tests module 114 passes the unique identifier of the breakpoint specified by the instruction. When the listener module 112 has completed processing it returns the results 116 of an action associated with the breakpoint and returns control to the tests module 114 which continues executing at the next instruction in the test code 120. In accordance with one or more embodiments of the present invention, the tests module 114 also outputs or stores the results 116. Alternatively, when the listener module 112 has completed processing it returns a pointer to a location of the results 116 of an action associated with the breakpoint and returns control to the tests module 114. The results 116 can be input to the rule library 104 to determine breakpoint settings for a next iteration of testing.

The listener module 112 receives the unique identifier of the breakpoint and can look it up in the breakpoint library 108 to determine whether the breakpoint is enabled, and a severity level associated with the breakpoint. If the breakpoint is not enabled, that is the breakpoint is turned off, the action performed by the listener module 112 is a return to the test code 120 without performing any additional actions. This action of determining whether the breakpoint is turned on and returning to the test code 120 can be tuned so that it results in a minimal delay in the execution of the test code 120.

If the listener module 112 determines, based on contents of the breakpoint library 108, that the breakpoint is turned on, the listener module 112 accesses the action library 110 to determine what action to take for the breakpoint. The exemplary action library 110 shown in FIG. 1 includes three actions and it should be appreciated that other embodiments may have fewer or more actions. In accordance with one or more embodiments of the present invention, the actions are tied to the severity level assigned to the breakpoint. For example, “Action 1” may be used when the severity level is high, “Action 2” may be used when the severity level is low, and “Action 3” may be used when the breakpoint is turned off. Example actions include but are not limited to: pause execution and wait for manual intervention; take a snapshot or dump of memory; increase buffers for and turn on additional diagnostic data capturing; validate contents in memory are as expected; inject an error in the code under test to force a recovery path; alter storage in the system to force a specific path in the code under test; and delay the processing in the code under test to force serialization or multi-threaded paths through the code under test. In accordance with one or more embodiments of the present invention, the recovery indicator indicates what logs or data to collect to diagnose that the code is functioning as expected after the action is performed when the breakpoint hits.

It is to be understood that the block diagram of FIG. 1 is not intended to indicate that the system 100 is to include all of the components shown in FIG. 1. Rather, the system 100 can include any appropriate fewer or additional components not illustrated in FIG. 1 (e.g., additional rule libraries, action libraries, programs, functional blocks, connections between functional blocks, modules, inputs, outputs, etc.). For example, all or a portion of the compiler 118 (or interpreter) can be located in the static analysis module 106 or in the tests module 114. Further, the embodiments described herein with respect to system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

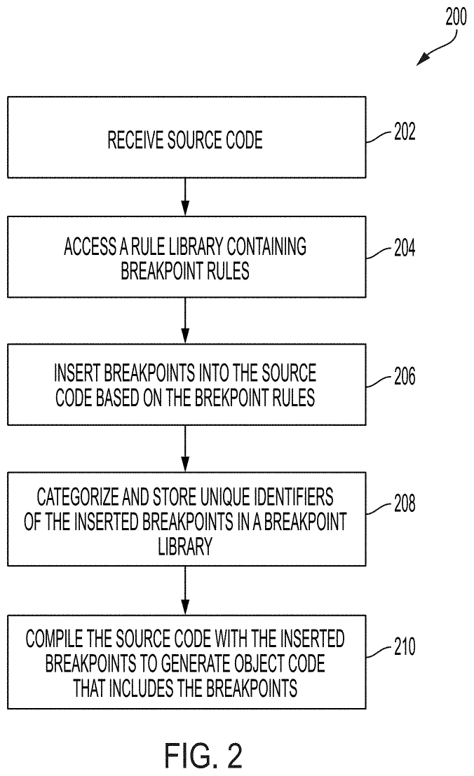

Turning now to FIG. 2, a process flow diagram of a method 200 for breakpoint generation from static analysis is generally shown according to one or more embodiments of the present invention. All or a portion of the processing shown in FIG. 2 can be implemented by the static analysis module 106 of FIG. 1.

As a computer developer is working on their software code, a static analysis tool can be run against their software code using rules to establish criteria to identify locations for breakpoints. Examples of such criteria include but are not limited to: using specific functions or macros such as obtaining a system resource (e.g., storage, locks, etc.), security vulnerabilities, areas high in any number of measurements of complexity, and decision points (e.g., if/else or switch/case conditionals). In accordance with one or more embodiments described herein, these breakpoints will then be added to a breakpoint library or set dynamically using a mechanism for categorizing the unique breakpoints, such as with naming conventions or through tagging.

Referring now to FIG. 2, at block 202, source code, such as source code 102 of FIG. 1, is received. At block 204, a rule library that contains breakpoint generation rules, such as rule library 104 of FIG. 1, is accessed. Breakpoints are inserted into the source code based on the breakpoint generation rules at block 206. At block 208, unique identifiers of the inserted breakpoints are stored in a breakpoint library, such as breakpoint library 108 of FIG. 1. Along with the unique identifiers, all or a subset of the breakpoints can be assigned to one or more categories as well as a severity level. At block 210, the source code with the inserted breakpoints is compiled, using for example compiler 118 of FIG. 1, into object code, such as test code 120 of FIG. 1, which includes the breakpoints.

The process flow diagram of FIG. 2 is not intended to indicate that the operations of the method 200 are to be executed in any particular order, or that all of the operations of the method 200 are to be included in every case. Additionally, the method 200 can include any suitable number of additional operations.

A tester can then use all of the breakpoints in the breakpoint library or a set of breakpoints (e.g., specific categories) within their test cases. The actions performed for each breakpoint can be based on a breakpoint tag such as a severity or impact indicator. Based on the category, or categories, there can also be different levels of functions or data collection to execute. For example, one or more embodiments of the present invention implement a multi-tiered severity indicator, such as high severity and low severity. Executing a breakpoint with a low severity can be configured to cause the error to be logged and the logged data to be stored. Executing a breakpoint with a high severity can be configured to cause the error to be logged and a snapshot (e.g., of contents of memory, processors, and/or related stacks or queues) to be dumped for later analysis while throwing an exception to the test case. In accordance with one or more embodiments of the present invention, throwing an exception to a test case includes raising a flag in a test case indicating a failure, and the test case handles the exception which in turn may initiate a dump. In this case the test case handles the event itself.

Additionally, in order to reduce performance implications, control flow and hotspot identification techniques can be taken to ensure that breakpoints are not placed automatically in high traffic code to prevent introducing significant performance penalties and overhead that would potentially alter the code path driven.

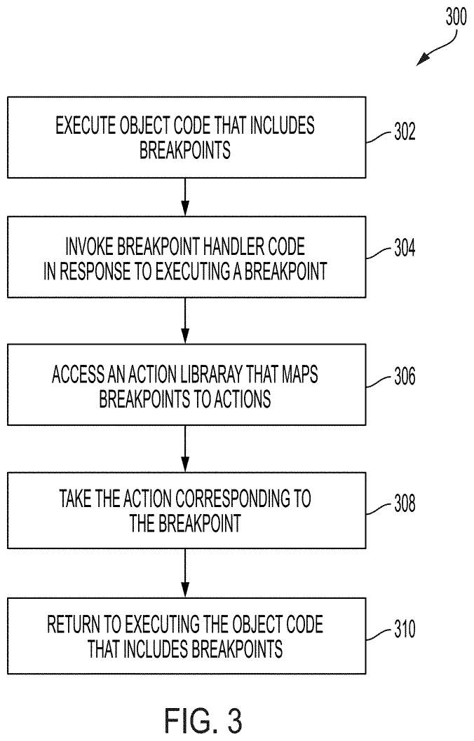

Turning now to FIG. 3, a process flow diagram of a method 300 for executing object code that includes breakpoints generated from static analysis is generally shown according to one or more embodiments of the present invention. All or a portion of the processing shown in FIG. 3 can be implemented by the tester module 114 and/or the listener module 112 of FIG. 1.

At block 302, object code, such as test code 120 of FIG. 1, is executed, for example by tests module 114 of FIG. 1. At block 304 a breakpoint handler, such as listener module 112 of FIG. 1, is invoked in response to executing an instruction in the object code that specifies a breakpoint. In accordance with one or more embodiments of the present invention, invoking the breakpoint handler includes transferring control to the breakpoint handler and supplying the breakpoint handler with the unique identifier of the specified breakpoint. At block 306, the breakpoint handler determines an action to take based on the unique identifier of the specified breakpoint. This can be performed, for example, by accessing an action library, such as action library 110 of FIG. 1, which specifies actions based on breakpoint identifiers and/or other breakpoint tags such as, but not limited to, a category of the breakpoint. At block 308, the breakpoint handler performs the action(s) and at block 310 returns control to object code.

The processing shown in FIG. 3 can be iterated with different test data and/or test scenarios, as well as with different breakpoints being enabled, or turned on. Additionally, the iterations can include different actions to take when a specific breakpoint or category of breakpoint is executed.

In accordance with one or more embodiments of the present invention, the object code with the inserted breakpoints can be used in a production environment with all of the breakpoints turned off until or unless testing of the code is required. In accordance with one or more embodiments of the present invention, the breakpoint handler doesn't run in the production environment. So, with no breakpoint handler running in the system, the breakpoints in the code are treated as no-operations (no-ops).

The process flow diagram of FIG. 3 is not intended to indicate that the operations of the method 300 are to be executed in any particular order, or that all of the operations of the method 300 are to be included in every case. Additionally, the method 300 can include any suitable number of additional operations.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

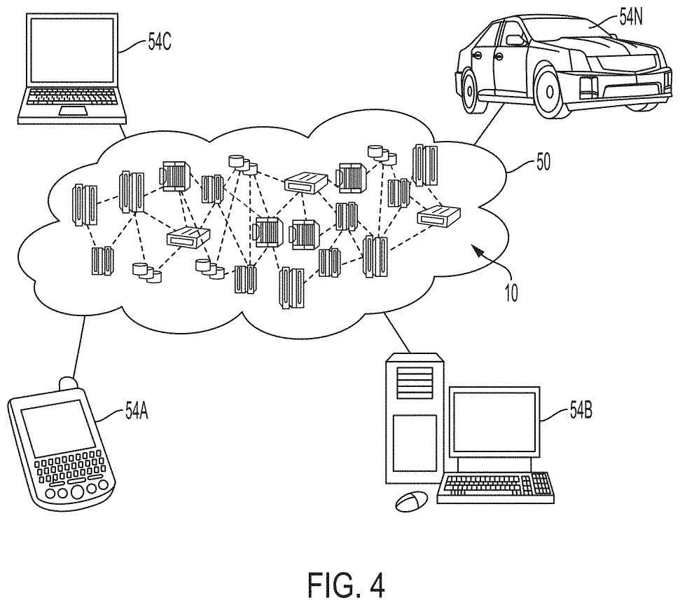

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

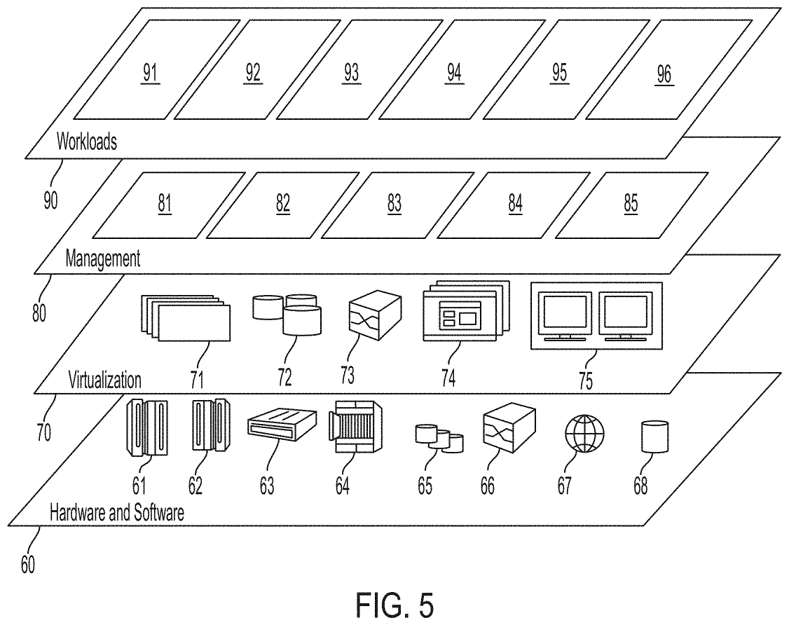

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and breakpoint generation 96.

It is understood that one or more embodiments of the present invention are capable of being implemented in conjunction with any type of computing environment now known or later developed.

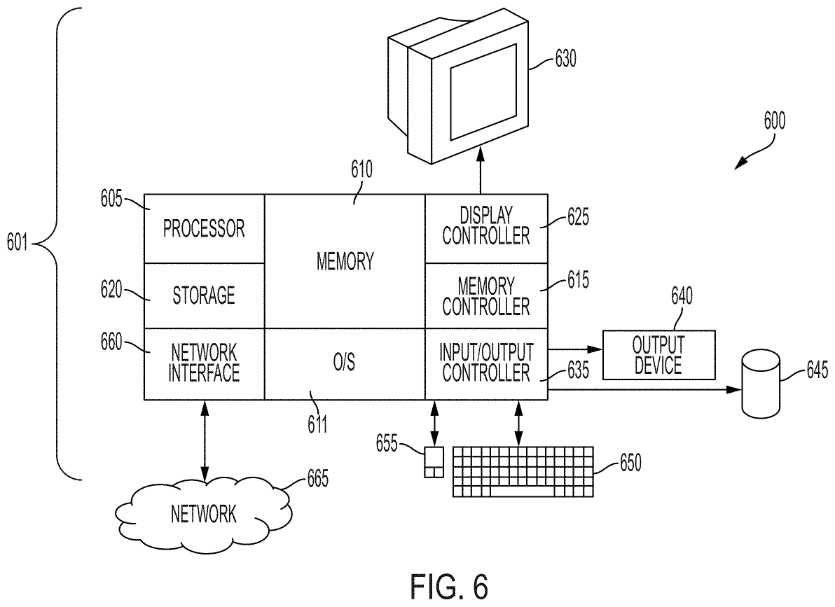

Turning now to FIG. 6, a computer system for breakpoint generation from static analysis is generally shown in accordance with one or more embodiments of the present invention. The methods described herein can be implemented in hardware, software (e.g., firmware), or a combination thereof. In one or more exemplary embodiments of the present invention, the methods described herein are implemented in hardware as part of the microprocessor of a special or general-purpose digital computer, such as a personal computer, workstation, minicomputer, or mainframe computer. The system 600 therefore may include general-purpose computer or mainframe 601 capable of running multiple instances of an O/S simultaneously.

In one or more exemplary embodiments of the present invention, in terms of hardware architecture, as shown in FIG. 6, the computer 601 includes one or more processors 605, memory 610 coupled to a memory controller 615, and one or more input and/or output (I/O) devices 640, 645 (or peripherals) that are communicatively coupled via a local input/output controller 635. The input/output controller 635 can be, for example but not limited to, one or more buses or other wired or wireless connections, as is known in the art. The input/output controller 635 may have additional elements, which are omitted for simplicity, such as controllers, buffers (caches), drivers, repeaters, and receivers, to enable communications. Further, the local interface may include address, control, and/or data connections to enable appropriate communications among the aforementioned components. The input/output controller 635 may include a plurality of sub-channels configured to access the output devices 640 and 645. The sub-channels may include fiber-optic communications ports.

The processor 605 is a hardware device for executing software, particularly that stored in storage 620, such as cache storage, or memory 610. The processor 605 can be any custom made or commercially available processor, a central processing unit (CPU), an auxiliary processor among several processors associated with the computer 601, a semiconductor based microprocessor (in the form of a microchip or chip set), a macroprocessor, or generally any device for executing instructions.

The memory 610 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 610 may incorporate electronic, magnetic, optical, and/or other types of storage media. Note that the memory 610 can have a distributed architecture, where various components are situated remote from one another, but can be accessed by the processor 605.

The instructions in memory 610 may include one or more separate programs, each of which comprises an ordered listing of executable instructions for implementing logical functions. In the example of FIG. 6, the instructions in the memory 610 a suitable operating system (OS) 611. The operating system 611 essentially controls the execution of other computer programs and provides scheduling, input-output control, file and data management, memory management, and communication control and related services.

In accordance with one or more embodiments of the present invention, the memory 610 may include multiple logical partitions (LPARs) each running an instance of an operating system. The LPARs may be managed by a hypervisor, which may be a program stored in memory 610 and executed by the processor 605.

In one or more exemplary embodiments of the present invention, a conventional keyboard 650 and mouse 655 can be coupled to the input/output controller 635. Other output devices such as the I/O devices 640, 645 may include input devices, for example but not limited to a printer, a scanner, microphone, and the like. Finally, the I/O devices 640, 645 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 600 can further include a display controller 625 coupled to a display 630.

In one or more exemplary embodiments of the present invention, the system 600 can further include a network interface 660 for coupling to a network 665. The network 665 can be an IP-based network for communication between the computer 601 and any external server, client and the like via a broadband connection. The network 665 transmits and receives data between the computer 601 and external systems. In an exemplary embodiment, network 665 can be a managed IP network administered by a service provider. The network 665 may be implemented in a wireless fashion, e.g., using wireless protocols and technologies, such as WiFi, WiMax, etc. The network 665 can also be a packet-switched network such as a local area network, wide area network, metropolitan area network, Internet network, or other similar type of network environment. The network 665 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 601 is a PC, workstation, intelligent device or the like, the instructions in the memory 610 may further include a basic input output system (BIOS) (omitted for simplicity). The BIOS is a set of essential software routines that initialize and test hardware at startup, start the OS 611, and support the transfer of data among the hardware devices. The BIOS is stored in ROM so that the BIOS can be executed when the computer 601 is activated.

When the computer 601 is in operation, the processor 605 is configured to execute instructions stored within the memory 610, to communicate data to and from the memory 610, and to generally control operations of the computer 601 pursuant to the instructions. In accordance with one or more embodiments of the present invention, computer 601 is an example of a cloud computing node 10 of FIG. 4.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discreet logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A method comprising:
receiving, by a processor, source code for a software program;
performing, by the processor, a static analysis of the source code based at least in part on one or more breakpoint generation rules, the static analysis comprising a code complexity analysis that identifies one or both of nested if statements and multiple loops in the source code;
inserting, by the processor, breakpoints into the source code based at least in part on the static analysis and the one or more breakpoint generation rules; and
compiling, by the processor, the source code with the inserted breakpoints into object code for the software program.

2. The method of claim 1, further comprising:
executing the object code,
wherein in response to executing an instruction in the object code that includes a breakpoint, a breakpoint handler is invoked to perform an action associated with the breakpoint.

3. The method of claim 2, wherein the action consists of returning to the object code.

4. The method of claim 2, wherein the action includes:
logging an identifier of the breakpoint and a timestamp of the current time; and
returning to the object code.

5. The method of claim 2, further comprising assigning, by the processor, severity levels to the breakpoints, wherein the action is based at least in part on a severity level assigned to the breakpoint.

6. The method of claim 2, further comprising categorizing, by the processor, the breakpoints into a plurality of categories, wherein the action is based at least in part on a category of the breakpoint.

7. The method of claim 2, further comprising updating the breakpoint generation rules based at least in part on an output of the executing the object code.

8. A system comprising:
one or more processors for executing computer readable instructions, the computer readable instructions controlling the one or more processors to perform operations comprising:
receiving, by a processor of the one or more processors, source code for a software program;
performing, by the processor, a static analysis of the source code based at least in part on one or more breakpoint generation rules, the static analysis comprising a code complexity analysis that identifies one or both of nested if statements and multiple loops in the source code;
inserting, by the processor, breakpoints into the source code based at least in part on the static analysis and the one or more breakpoint generation rules; and
compiling, by the processor, the source code with the inserted breakpoints into object code for the software program.

9. The system of claim 8, wherein the operations further comprise:
executing the object code,
wherein in response to executing an instruction in the object code that includes a breakpoint, a breakpoint handler is invoked to perform an action associated with the breakpoint.

10. The system of claim 9, wherein the action consists of returning to the object code.

11. The system of claim 9, wherein the action includes:
logging an identifier of the breakpoint and a timestamp of the current time; and
returning to the object code.

12. The system of claim 9, wherein the operations further comprise assigning, by the processor, severity levels to the breakpoints, wherein the action is based at least in part on a severity level assigned to the breakpoint.

13. The system of claim 9, wherein the operations further comprise categorizing, by the processor, the breakpoints into a plurality of categories, wherein the action is based at least in part on one of the categories of the breakpoint.

14. The system of claim 9, wherein the operations further comprise updating the breakpoint generation rules based at least in part on an output of the executing the object code.

15. A computer program product comprising a computer readable storage medium having program instructions embodied therewith, the program instructions executable by a processor to cause the processor to perform operations comprising:
receiving, by the processor, source code for a software program;
performing, by the processor, a static analysis of the source code based at least in part on one or more breakpoint generation rules, the static analysis comprising a code complexity analysis that identifies one or both of nested if statements and multiple loops in the source code;
inserting, by the processor, breakpoints into the source code based at least in part on the static analysis and the one or more breakpoint generation rules; and
compiling, by the processor, the source code with the inserted breakpoints into object code for the software program.

16. The computer program product of claim 15, wherein the operations further comprise:
executing the object code,
wherein in response to executing an instruction in the object code that includes a breakpoint, a breakpoint handler is invoked to perform an action associated with the breakpoint.

17. The computer program product of claim 16, wherein the operations further comprise assigning, by the processor, severity levels to the breakpoints, wherein the action is based at least in part on a severity level assigned to the breakpoint.

18. The computer program product of claim 16, wherein the action consists of returning to the object code.

19. The computer program product of claim 16, wherein the action includes:
logging an identifier of the breakpoint and a timestamp of the current time; and
returning to the object code.

20. The computer program product of claim 16, wherein the operations further comprise categorizing, by the processor, the breakpoints into a plurality of categories, wherein the action is based at least in part on one of the categories of the breakpoint.
